(19) United States
(12) Patent Application Publication
(10) Pub. No.: US 2009/0093255 A1
(43) Pub. Date: Apr. 9, 2009

(54) ADJUSTING MULTI-CARRIER ALLOCATION IN WIRELESS NETWORKS

(75) Inventor: Srinivasan Balasubramanian, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/244,196

(22) Filed: Oct. 2, 2008

Related U.S. Application Data
(60) Provisional application No. 60/978,054, filed on Oct. 5, 2007.

(51) Int. Cl. H04W 88/00

(52) U.S. Cl. 455/450; 370/329

(57) ABSTRACT

Systems and methodologies are described that facilitate adjusting allocation of carriers in wireless communications. A mobile device can establish communication with a base station over a number of allocated carriers for simultaneous transmission thereover. The mobile device can experience a decrease in power amplifier (PA) headroom causing dropping of at least one carrier and can report the drop to the base station. The base station can subsequently await a carrier request message from the mobile device before allocating additional carriers, or can allocate an additional carrier based on a determination that the mobile device can handle the new carrier. The mobile device can transmit a carrier request message when the PA headroom returns to a threshold level.

### CROSS-REFERENCE TO RELATED APPLICATIONS

The present Application for Patent claims priority to Provisional Application No. 60/978,054 entitled “METHOD AND APPARATUS FOR SENDING A CARRIER REQUEST MESSAGE” filed Oct. 5, 2007, and assigned to the assignee hereof and hereby expressly incorporated by reference herein.

### BACKGROUND

I. Field

The following description relates generally to wireless communications, and more particularly to adjusting multi-carrier allocation in wireless communication networks.

II. Background

Wireless communication systems are widely deployed to provide various types of communication content such as, for example, voice, data, and so on. Typical wireless communication systems may be multiple-access systems capable of supporting communication with multiple users by sharing available system resources (e.g. bandwidth, transmit power, . . . ). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long term evolution (LTE), ultra mobile broadband (UMB), and/or multi-carrier wireless specifications such as evolution data optimized (EV-DO), one or more revisions thereof, etc.

Generally, wireless multiple-access communication systems may simultaneously support communication for multiple mobile devices. Each mobile device may communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations may be established via single-input single-output (SISO) systems, multiple-input single-output (MISO) systems, multiple-input multiple-output (MIMO) systems, and so forth. In addition, mobile devices can communicate with other mobile devices (and/or base stations with other base stations) in peer-to-peer wireless network configurations.

MIMO systems commonly employ multiple (NT) transmit antennas and multiple (NR) receive antennas for data transmission. The antennas can relate to both base stations and mobile devices, in one example, allowing bi-directional communication between the devices on the wireless network. In multi-carrier systems, a plurality of carriers can be allocated for communication over one or more of the multiple antennas to facilitate simultaneous communication thereover, which inherently increases communication throughput between devices utilizing the multiple carriers. The base station can allocate the plurality of carriers to the mobile device upon establishment of communication.

### SUMMARY

The following presents a simplified summary of one or more embodiments in-order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more embodiments and corresponding disclosure thereof, various aspects are described in connection with facilitating adjusting allocation of multiple carriers in wireless communications. According to an example, an access point can allocate a number of carriers for use by a mobile device in communicating with the access point. The access point can increase and decrease the number of carriers allocated to the mobile device. In one example, the mobile device can drop a carrier due to a change in one or more communication parameters and notify the access point of the drop. The mobile device can operate without all carriers until the one or more communication parameters change again and/or a carrier is received from the access point based at least in part on a determination that the mobile device can properly utilize the carrier.

According to related aspects, a method for modifying a number of carriers utilized in a wireless communication network is provided. The method can include establishing communications with an access point utilizing a plurality of carriers and reporting dropping of one or more of the carriers as a result of a change in one or more communication parameters to the access point. The method can also include receiving one or more additional carriers from the access point following a disparate change in the one or more communication parameters.

Another aspect relates to a wireless communications apparatus. The wireless communications apparatus can include at least one processor configured to establish communications with an access point over a number of carriers assigned by the access point and drop one or more of the carriers as a result of a change in one or more communications parameters. The processor is further configured to request one or more additional carriers based at least in part on a disparate change to the one or more communications parameters. The wireless communications apparatus further comprises a memory coupled to the at least one processor.

Yet another aspect relates to a wireless communications apparatus that facilitates adjusting a number of carriers utilized in wireless communications. The wireless communications apparatus can comprise means for establishing communications with an access point utilizing a number of carriers and means for indicating a decrease in a number of carriers utilized based at least in part on a change to a communication parameter. The wireless communications apparatus can additionally include means for receiving one or more additional carriers based at least in part on a disparate change to the communication parameter.

Still another aspect relates to a computer program product, which can have a computer-readable medium including code for causing at least one computer to establish communications with an access point utilizing a plurality of carriers. The computer-readable medium can also comprise code for causing the at least one computer to report dropping of one or more of the carriers as a result of a change in one or more communication parameters to the access point. Moreover, the computer-readable medium can comprise code for causing the at least one computer to receive one or more additional carriers from the access point following a disparate change in the one or more communication parameters.

Another aspect relates to an apparatus. The apparatus comprises a a transceiver that facilitates establishing communications with an access point over a plurality of assigned carriers and a carrier dropper that transmits an indication of one or more dropped carriers to the access point based at least in part on a change of a communications parameter. The apparatus further comprises a carrier receiver that receives one or more additional carriers from the access point based at least in part on a disparate change to the communications parameter.

According to a further aspect, a method that facilitates allocating carriers in wireless communication networks is provided. The method comprises allocating a plurality of carriers to a mobile device according to a maximum number of allocable carriers associated with the mobile device. The method also includes receiving an indication of dropping one or more of the allocated carriers from the mobile device and allocating an additional carrier to the mobile device based at least in part on determining an availability in the mobile device for the additional carrier.

Another aspect relates to a wireless communications apparatus. The wireless communications apparatus can include at least one processor configured to allocate a plurality of carriers to a mobile device to facilitate communication therewith and receive a notification of a drop in at least one of the carriers by the mobile device. The processor is further configured to allocate an additional carrier to the mobile device based at least in part on a subsequently received request for the additional carrier. The wireless communications apparatus further comprises a memory coupled to the at least one processor.

Yet another aspect relates to a wireless communications apparatus for adjusting carrier allocation of one or more mobile devices. The wireless communications apparatus can comprise means for allocating a plurality of carriers to a mobile device to facilitate communication therewith and means for receiving notification of a dropped carrier related to the mobile device. The wireless communications apparatus can additionally include means for allocating an additional carrier to the mobile device based at least in part on a request from the mobile device for the additional carrier.

Still another aspect relates to a computer program product, which can have a computer-readable medium including code for causing at least one computer to allocate a plurality of carriers to a mobile device according to a maximum number of allocable carriers associated with the mobile device. The computer-readable medium can also comprise code for causing the at least one computer to receive an indication of dropping one or more of the allocated carriers from the mobile device. Moreover, the computer-readable medium can comprise code for causing the at least one computer to allocate an additional carrier to the mobile device based at least in part on determining an availability in the mobile device for the additional carrier.

Another aspect relates to an apparatus. The apparatus comprises a transceiver that communicates with one or more mobile devices over a plurality of allocated carriers and a drop carrier notification receiver that receivers an indication that the mobile device has dropped one or more of the allocated carriers. The apparatus further comprises a carrier allocator that allocates an additional carrier to the mobile device based at least in part on determining availability in the mobile device for the additional carrier.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 is an illustration of a wireless communication system in accordance with various aspects set forth herein.

FIG. 2 is an illustration of an example communications apparatus for employment within a wireless communications environment.

FIG. 3 is an illustration of an example wireless communications system that effectuates adjusting carrier allocation to a wireless device.

FIG. 4 is an illustration of an example state diagram for adjusting allocation of carriers in wireless communications.

FIG. 5 is an illustration of an example methodology that facilitates dropping and requesting carriers in wireless communications.

FIG. 6 is an illustration of an example methodology that facilitates receiving drop notification and allocating additional carriers in wireless communications.

FIG. 7 is an illustration of an example mobile device that facilitates dropping and requesting additional carriers.

FIG. 8 is an illustration of an example system that receives drop notification and allocates additional carriers.

FIG. 9 is an illustration of an example wireless network environment that can be employed in conjunction with the various systems and methods described herein.

FIG. 10 is an illustration of an example system that drops and requests additional carrier assignment from an access point.

FIG. 11 is an illustration of an example system that receives drop notification for carriers and assigns additional carriers in wireless communications.

### DETAILED DESCRIPTION

Various embodiments are now described with reference to the drawings, wherein like reference numerals are used to refer to like elements throughout. In the following description, for purposes of explanation, numerous specific details are set forth in-order to provide a thorough understanding of one or more embodiments. It may be evident, however, that such embodiment(s) can be practiced without these specific details. In other instances, well-known structures and devices are shown in block diagram form in-order to facilitate describing one or more embodiments.

As used in this application, the terms “component,” “module,” “system,” and the like are intended to refer to a computer-related entity, either hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

Furthermore, various embodiments are described herein in connection with a mobile device. A mobile device can also be called a system, subscriber unit, subscriber station, mobile station, mobile, remote station, remote terminal, access terminal, user terminal, terminal, wireless communication device, user agent, user device, or user equipment (UE). A mobile device can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem. Moreover, various embodiments are described herein in connection with a base station. A base station can be utilized for communicating with mobile device(s) and can also be referred to as an access point, Node B, evolved Node B (eNode B or eNB), base transceiver station (BTS) or some other terminology.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data.

The techniques described herein may be used for various wireless communication systems such as code division multiple access (CDMA), time division multiple access (TDMA), frequency division multiple access (FDMA), orthogonal frequency division multiple access (OFDMA), single carrier frequency domain multiplexing (SC-FDMA) and other systems. The terms “system” and “network” are often used interchangeably. A CDMA system may implement a radio technology such as Universal Terrestrial Radio Access (UTRA), CDMA2000, etc. UTRA includes Wideband-CDMA (W-CDMA) and other variants of CDMA. CDMA2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is an upcoming release that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). CDMA2000 and UMB are described in documents from an organization named “3rd Generation Partnership Project 2” (3GPP2). The techniques described herein can also be utilized in evolution data optimized (EV-DO) standards, such as 1xEV-DO revision B or other revisions, and/or the like. Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

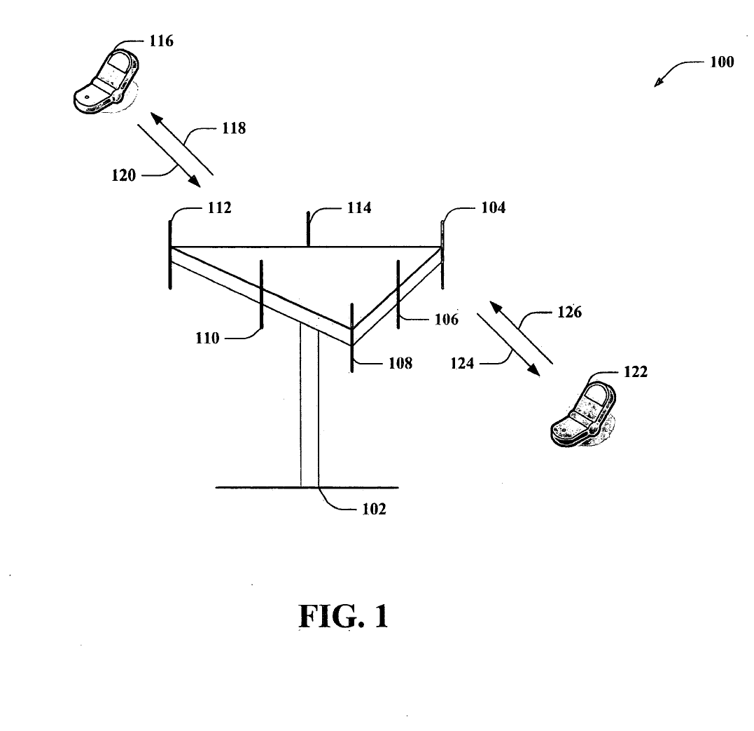

Referring now to FIG. 1, a wireless communication system 100 is illustrated in accordance with various embodiments presented herein. System 100 comprises a base station 102 that can include multiple antenna groups. For example, one antenna group can include antennas 104 and 106, another group can comprise antennas 108 and 110, and an additional group can include antennas 112 and 114. Two antennas are illustrated for each antenna group; however, more or fewer antennas can be utilized for each group. Base station 102 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

Base station 102 can communicate with one or more mobile devices such as mobile device 116 and mobile device 122; however, it is to be appreciated that base station 102 can communicate with substantially any number of mobile devices similar to mobile devices 116 and 122. Mobile devices 116 and 122 can be, for example, cellular phones, smart phones, laptops, handheld communication devices, handheld computing devices, satellite radios, global positioning systems, PDAs, and/or any other suitable device for communicating over wireless communication system 100. As depicted, mobile device 116 is in communication with antennas 112 and 114, where antennas 112 and 114 transmit information to mobile device 116 over a forward link 118 and receive information from mobile device 116 over a reverse link 120. Moreover, mobile device 122 is in communication with antennas 104 and 106, where antennas 104 and 106 transmit information to mobile device 122 over a forward link 124 and receive information from mobile device 122 over a reverse link 126. In a frequency division duplex (FDD) system, forward link 118 can utilize a different frequency band than that used by reverse link 120, and forward link 124 can employ a different frequency band than that employed by reverse link 126, for example. Further, in a time division duplex (TDD) system, forward link 118 and reverse link 120 can utilize a common frequency band and forward link 124 and reverse link 126 can utilize a common frequency band.

Each group of antennas and/or the area in which they are designated to communicate can be referred to as a sector of base station 102. For example, antenna groups can be designed to communicate to mobile devices in a sector of the areas covered by base station 102. In communication over forward links 118 and 124, the transmitting antennas of base station 102 can utilize beamforming to improve signal-to-noise ratio of forward links 118 and 124 for mobile devices 116 and 122. Also, while base station 102 utilizes beamforming to transmit to mobile devices 116 and 122 scattered randomly through an associated coverage, mobile devices in neighboring cells can be subject to less interference as compared to a base station transmitting through a single antenna to all its mobile devices. Moreover, mobile devices 116 and 122 can communicate directly with one another using a peer-to-peer or ad hoc technology as depicted.

According to an example, system 100 can be a multiple-input multiple-output (MIMO) communication system. Further, system 100 can utilize substantially any type of duplexing technique to divide communication channels (e.g. forward link, reverse link, . . . ) such as FDD, TDD, and the like. In one example, the base station 102 and/or mobile devices 116/122 can receive information from each other and/or additional mobile devices/base stations by employing a wideband multicarrier transceiver (e.g., rake receiver), which can be integrated or otherwise. For example, the wideband multicarrier transceiver (not shown) can comprise multiple receivers that simultaneously receive signals from disparate frequencies over a plurality of carriers. Carriers, in this context, can refer to frequency carriers, or other types of bandwidth portions, such as OFDM tones, or other minimum allocable units such as a number of slots over a number of subcarriers schedulable in a subframe, and/or the like. Thus, increased throughput is achieved by the base station 102 and/or mobile devices 116/122, as it can receive and demodulate multiple signals over a given time period. Moreover, the base station 102 can dynamically allocate carriers for receiving data based at least in part on determinations made at the base station 102 and/or mobile devices 116/122, as described herein.

According to an example, the mobile devices 116/122 can establish communications with the base station 102 receiving a maximum number of allocable carriers for the mobile devices 116/122. In one example, the maximum number can be hardcoded in the mobile devices 116/122 or base station 102, configured as a network parameter, received from one or more disparate network components, etc. The base station 102, in one example, can allocate and deallocate carriers to the mobile devices 116/122 according to independent considerations without action from the mobile devices 116/122. For example, the base station 102 can deallocate carriers from mobile device 116 and/or 122 to provide to other devices, which can be based on subscription levels, link activity, demonstrated need for carriers, and/or the like. However, where the mobile device 116 and/or 122 cannot effectively utilize the assigned carriers (e.g., due to insufficient or decreasing power amplifier (PA) headroom), it can drop one or more carriers. For example, the mobile device 116 and/or 122 can notify base station 102 of the dropped carrier, which can cause the base station 102 to take specified actions with respect to reallocating a carrier to replace the dropped carrier.

In one example, the base station 102 can await receipt of an explicit request from the mobile device 116 and/or 122 to add an additional carrier (e.g., when PA headroom returns to a threshold level) before assigning the carrier. In another example, the base station 102 can evaluate the dropped carrier to determine loading conditions thereof and can allocate an additional carrier, via transmitting a traffic channel assignment (TCA) for example, with lesser loading conditions to the mobile device 116 and/or 122. In yet another example, the base station 102 can periodically evaluate a reverse link activity level for the mobile device 116 and/or 122 to determine when activity reaches a given threshold to allocate an additional carrier. In any case, upon receiving the additional carrier allocation, the mobile device 116 and/or 122 can determine whether it can handle the additional carrier (e.g., based on PA headroom and/or other measures). If not, it can drop the carrier and again notify the base station 102; if so, it can utilize the carrier in subsequent communications. In one example, continuous dropping of carriers can be detected and handled at the mobile device 116/122 and/or the base station 102, as described herein.

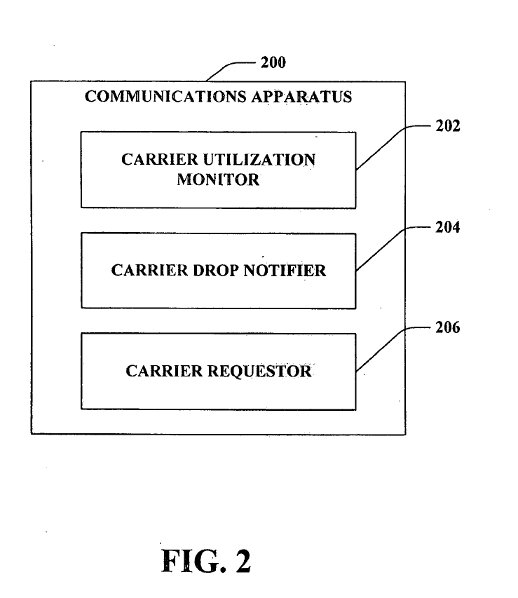

Turning to FIG. 2, illustrated is a communications apparatus 200 for employment within a wireless communications environment. The communications apparatus 200 can be a base station or a portion thereof, a mobile device or a portion thereof, or substantially any communications apparatus that receives data transmitted in a wireless communications environment. The communications apparatus 200 can include a carrier utilization monitor 202 that determines whether carriers allocated to the communications apparatus 200 are being utilized effectively (e.g. based at least in part on throughput, available PA headroom, and/or the like), a carrier drop notifier 204 that can indicate drop of a carrier, and a carrier requestor 206 that can request an additional carrier based at least in part on a determination that the communications apparatus 200 can handle the carrier (e.g., has enough PA headroom for loading the carrier).

According to an example, as described, the communications apparatus 200 can communicate with one or more disparate devices (not shown) to receive wireless access service. In one example, the communications apparatus 200 can be allocated a maximum number of carriers upon connection establishment for communicating thereover. It is to be appreciated that simultaneous communication over a number of carriers can increase communication throughput. In addition, the maximum number of carriers allocable to the communications apparatus 200 can be defined in the apparatus 200 and/or specified by one or more disparate network components (not shown), according to a network specification, and/or the like. Moreover, carriers can be allocated and deallocated by a disparate device according to considerations independent of the communications apparatus 200 as described; thus, the communications apparatus 200 can utilize the carriers given at a specified point in time to communicate over the wireless network.

In one example, the communications apparatus 200 can become overloaded such that communication resources cannot be effectively utilized. This can happen, for example, where a carrier experiences high loading conditions, activity level, signal degradation, etc. forcing the communications apparatus 200 to dedicate more resources to the carrier. Taking resources away from other carriers can be detrimental to receiving data over those carriers from which resources are taken. The carrier utilization monitor 202 can monitor for such behavior, in one example. The behavior can be recognized by the carrier utilization monitor 202 based at least in part on throughput over the carriers (and/or monitoring a decrease in such, for example). When a communication parameter changes and/or is otherwise modified, such as throughput over a carrier or PA headroom falling below a threshold, the communication apparatus 200 can drop a carrier. The carrier drop notifier 204 can indicate the drop to an allocator of the carrier (such as an access point, as described). In one example, the carrier drop notifier 204 can transmit a ReverseCDMAChannelDropped message to indicate the drop. As described, the message can affect subsequent carrier allocations to the communications apparatus 200, which can depend on factors related to the dropped carrier, such as loading conditions, activity level, etc. It is to be appreciated, in one example, that a carrier request message can be utilized to request a smaller number of carriers than is allocated.

According to an example, the indication from the carrier drop notifier 204 can notify that the communications apparatus 200 should not receive additional carriers until requested. Thus, upon notifying of the carrier drop, the communications apparatus 200 can be allocated a number of carriers below the maximum. When a disparate change or modification to a different or the same communication parameter occurs, such as PA headroom increasing, however, the communications apparatus 200 can handle an additional carrier and can indicate such by requesting an additional carrier via carrier requestor 206. In one example, the carrier requestor 206 can determine the availability to handle the carrier based at least in part on determining the PA headroom is exceeding a threshold level to handle the additional carrier. Upon making the determination, the carrier requester 206 can request the additional carrier for subsequent communication.

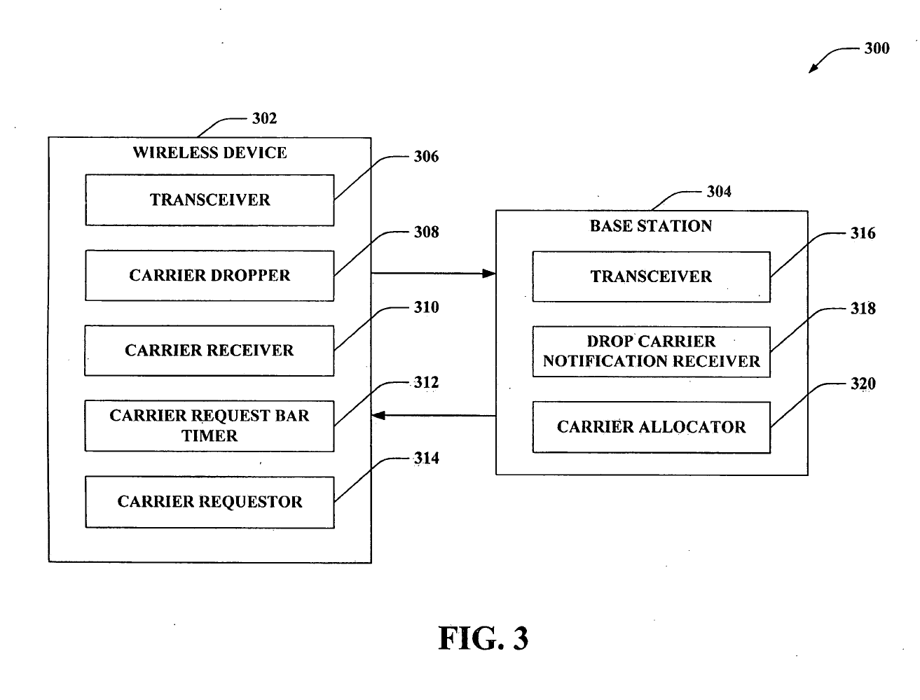

Now referring to FIG. 3, illustrated is a wireless communications system 300 that facilitates additional carrier request and allocation. Wireless device 302 can be a mobile device (including not only independently powered devices, but also modems, for example), or portion thereof. In one example, wireless device 302 can transmit information to base station 304 over a reverse link or uplink channel; further wireless device 302 can receive information from base station 304 over a forward link or downlink channel. Moreover, system 300 can be a MIMO system and/or can conform to one or more wireless network system specifications (e.g., EV-DO, 3GPP, 3GPP2, 3GPP LTE, etc.), and the wireless device 302 and base station 304 can simultaneously communicate with each other over multiple carriers. Also, the components and functionalities shown and described below in the wireless device 302 can be present in the base station 304 as well and vice versa, in one example; the configuration depicted excludes these components for ease of explanation.

Wireless device 302 includes a transceiver 306 for communicating with base station 304 and/or one or more access points in a wireless network over one or more carriers, a carrier dropper 308 that can drop one or more of the carriers based at least in part on a change in a communication parameter and notify of the dropped carrier, a carrier receiver 310 that can obtain additional carriers from the base station 304, a carrier request bar timer 312 that can specify a time during which additional carriers cannot be requested to prevent flooding and continually dropping carriers as further described herein, and a carrier requestor 314 that can request additional carriers from the wireless device. In one example, the communication parameter can be a power amplifier (PA) headroom. The change in PA headroom can relate to a decrease to the point that a carrier can no longer be effectively utilized. In this case, the carrier dropper 308 can drop the carrier and notify the base station 304 of such. A subsequent increase in PA headroom, for example, can allow the carrier receiver 310 to receive an additional carrier from the base station 304, whether resulting from a request by the carrier requestor 314 or otherwise, as described herein.

Base station 304 can include a transceiver 316 that facilitates communication with the wireless device 302 over a plurality of assigned carriers, a drop carrier notification receiver 318 that can receive an indication of dropping one or more carriers from wireless device 302, and a carrier allocator 320 that can allocate one or more additional carriers to the wireless device 302 based at least in part on a determined availability of the wireless device 302 to handle the additional carrier. In one example, the determined availability can be a received request for the additional carrier and/or other observations made regarding the wireless device 302 as described further herein.

According to an example, the wireless device 302 can establish communications with the base station 304 over transceiver 306 receiving multiple allocated carriers. In one example, the wireless device 302 can handle a maximum number of carriers; this maximum can be hardcoded in the wireless device, specified by a network parameter, determined by the base station 304, etc. In any case, the carrier allocator 320 can allocate up to the maximum number of carriers to the wireless device 302 depending on available resources in the base station 304. During communications, the carrier allocator 320 can remove and add carriers to communication with the wireless device 302 at will (e.g. based solely on considerations of the base station 304, such as available resources, addition or removal of carrier for other devices having varying subscriber levels, and/or the like) so long as it does not add over the maximum for the given wireless device 302. Thus, at substantially any point in the communication, wireless device 302 can be allocated anywhere from 1 to the maximum number of carriers from the carrier allocator 320 of the base station 304 depending on considerations at least partially external to the wireless device 302.

In addition, the wireless device 302 can drop carriers when it cannot handle them based on a change in communication parameters and/or can indicate to the base station 304 when it can handle one or more carriers not to exceed the maximum number specified in communication establishment. In one example, as mentioned, the wireless device 302 can experience a decrease in PA headroom such that it can no longer effectively communicate over one or more allocated carriers. In one example, the carrier requestor 314 can transmit a request to the base station 304 for allocation of a lesser number of carriers. In another example, the carrier dropper 308 can drop the carrier and notify the base station 304 of the drop. According to a specific example, the wireless device can transmit a ReverseCDMAChannelDropped message to the base station 304 to indicate the dropped carrier. The drop carrier notification receiver 318 can receive the indication of dropped carrier, and the carrier allocator 320 can accordingly reduce the number of allocable carriers to the wireless device 302 until it receives an indication of availability for additional carriers. Once such indication is received, the carrier allocator 320 can attempt to allocate an additional carrier to the wireless device 302, which can additionally be based on base station 304 considerations as well, such as available resources, etc., as described above.

In one example, the indication of availability for one or more carriers can be received as a request for additional carriers from carrier requestor 314. In this example, the wireless device 302 can experience an increase in PA headroom (subsequent the decrease) such that it is now able to handle one or more carriers. Thus, the carrier requester 314 sends a request message to the base station 304 for additional carrier allocation. In another example, however, the carrier allocator 320 can determine that wireless device 302 can handle an additional carrier and can attempt to allocate the carrier to it (e.g., via unsolicited traffic channel assignment (TCA), etc.). This determination can be made based at least in part on network topology/configuration, provisioning of the multiple carriers, and/or the like. In addition, the determination can be made based at least in part on loading conditions for the additional carrier. In one example, the carrier allocator 320 makes the determination based at least in part on comparing the loading conditions of the additional carrier to that of a previously dropped carrier. Thus, in one example, if the carrier dropper 308 previously dropped carrier having high loading conditions, the carrier allocator 320 can allocate a carrier with lower loading conditions in case the wireless device 302 can potentially handle the lower conditioned carrier. If it cannot, the carrier dropper 308 can simply drop the newly allocated lower conditioned carrier, for example.

In an example, if the carrier dropper 308 continues to drop newly allocated carriers, the carrier allocator 320 can cease allocating the carriers until a carrier request is received from the carrier requestor 314. In another example, the carrier allocator 320 can monitor the reverse link to detect stable receiving conditions before attempting to allocate one or more carriers to the wireless device 302. This can take place regardless of whether the carrier requestor 314 has requested an additional carrier or whether the base station 304 has otherwise determined an additional carrier should be allocated to the wireless device 302. Moreover, the carrier allocator 320 can also evaluate the reverse link activity level to determine candidate carriers for allocation; thus, for example, if the reverse link activity level is high for the wireless device 302, the carrier allocator 320 can select a carrier with lower loading conditions for allocation to the wireless device 302. In one example, there can be carriers that the carrier allocator 320 will not allocate to any wireless device until the loading conditions decrease or stabilize, for example.

Furthermore, continually dropping carriers can also be handled at the wireless device 302 such that carrier requestor 314 can request additional carriers based on a carrier request bar timer 312. Thus, when requested carriers are dropped by the carrier dropper 308 within a period of time of being requested, the carrier requester 314 can determine that wireless device 302 is in an aggressive drop state. The carrier request bar timer 312 can subsequently be set to prohibit requesting additional carriers so as not to flood the base station 304 with requests or itself with trying to utilize the carrier that probably will be dropped due to lack of PA headroom, for example. According to an example, the carrier requester 314 can evaluate historical carrier requests and drops over a specified period of time to determine when to enter the aggressive drop state. This can be based on a number of requests and drops in a specified period of time, an average time for holding an allocated carrier before dropping it, and/or the like. The carrier request bar timer 312 can be set for a time based at least in part on the evaluated historical requests. In one example, there can be threshold numbers of requests that map to timer lengths, for example. Once the timer expires and/or when an additional carrier is received by the carrier receiver 310 and utilized for a period of time, which can be governed by another timer, the aggressive drop state can be removed, and normal carrier allocation following carrier dropping can be resumed, for example.

In addition, the carrier requester 314 can evaluate other communication parameters in determining whether to request the additional carrier, such as current activity. For example, current activity can be measured over the carrier as a function of throughput or signal quality. Where the current activity is high, for example, with a low throughput, the carrier requester 314 can request an additional carrier (if other factors apply such as headroom) to ease processing burden on the other carriers. If the wireless device 302 receives and initializes an additional carrier from the carrier allocator 320, it can utilize the carrier in subsequent communications with the base station 304.

In one example, the system 300 can utilize the following pseudo-code to adjust carrier allocation as described:
M=Maximum number of carriers supported by the mobile device when in a connection.
C=Current number of carriers allocated to the mobile device when in a connection.
P=Number of carriers for which the mobile device currently has PA headroom available.
R=Number of carriers that the mobile device indicated in the CarrierRequest message sent to the access point.
D=A flag to indicate if the mobile device dropped one or more carriers due to PA headroom conditions.
T1=Detect Aggressive Drop timer; Minimum time between sending of CarrierRequest requesting for additional carriers and the subsequent additional carrier allocation resulting in a ReverseCDMAChannelDropped. If one or more carriers are dropped prior to this timer expiration, the mobile device considers this to be an aggressive drop and initiates a backoff for the next CarrierRequest message sent by the mobile. Default value of Ti=2 secs.
T2=CarrierRequest Backoff timer; The backoff timer used by the mobile device when an aggressive ReverseCDMAChannelDropped message is detected for the next CarrierRequest message sent by the mobile. This is the minimum timer after the mobile has sent a ReverseCDMAChannelDropped message that is considered an aggressive drop before the mobile is allowed to send a CarrierRequest message. Default value of T2=5 secs.
A=Flag to indicate if the mobile has currently detected an aggressive drop.

Mobile device connection setup the variables are initialized to
M=3
C=Number of carriers assigned by the access point in the TCA
P=3
R=3
D=False
A=False

As the radio conditions change in the mobile device, it updates P to represent the current number of carriers for which it has PA headroom available. C is updated based on the TCAs sent by the access point.
When mobile device encounters PA headroom limitations to handle the current assigned number of carriers, the mobile device drops one or more carriers and sets
   D=True
   R=P
   If the time between CarrierRequest and a subsequent ReverseCDMAChannelDropped is <T1 then,
      A=True
When (D=True)
   When ((P>R) && ((A==False)∥((A==True) && (Time between ReverseCDMAChannelDropped and subsequent CarrierRequest>T2)))
      Mobile device sends CarrierRequest message with the number of carriers set to P.
      Update R=P.
      Set A=False.
   When (C>R)
      Set R=C.
      Set A=False.
   When (R=M)
      Set D=False.

According to yet another example, the wireless device 302 can move about a wireless service area handing communications over to various base stations (not shown) where one type of base station can be incompatible with multicarrier architectures. In this example, the wireless device 302 can utilize a single carrier to communicate with the base station (not shown) as the base station cannot support carrier request or drop notification since only a single carrier is utilized. In addition, upon handing over communications, the carrier requester 314 and/or carrier dropper 308 can store context of the carriers requested and/or dropped carriers for which notification was sent. In this regard, upon returning to a region utilizing a multicarrier capable base station, such as base station 304, the carrier requester 314 can request the previous number of carriers and/or the carrier dropper 308 can drop a previous number of carriers to maintain previous communications before entering the single carrier region, for example.

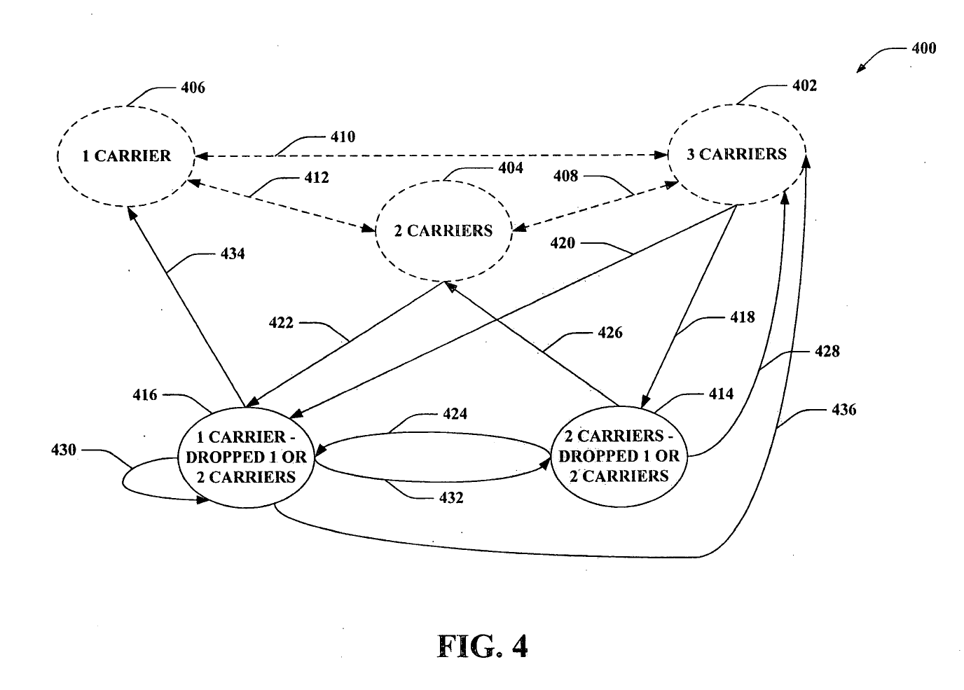

Turning now to FIG. 4, a state diagram for adjusting allocation of carriers in wireless communications 400 is illustrated. As described, a mobile device can initially be allocated a maximum number carriers. In this example, the maximum is 3 carriers and are allocated at 402. An access point can decrease the number of carriers allocated to the mobile device to 2 carriers at 404 as shown by the transition at 408, and to 1 carrier at 406 as shown by the transition at 410. In addition, where a mobile device has 2 allocated carriers at 404, the access point can decrease to 1 carrier at 406 as shown by the transition at 412. The mobile device can move between states 402, 404, and 406 as described based on access point considerations and actions.

In some cases, however, the mobile device can transition between states to drop carriers when it cannot handle one or more allocated carriers, as described (e.g., due to low PA headroom and/or the like). From a 3 carrier state 402, for example, the mobile device can go to a 2 carrier state from dropping a carrier 414 via transition 418 or to 1 carrier state from dropping two carriers 416 via transition 420. In addition, the mobile device can send a notification of carrier drop to the access point (not shown) as described. Similarly, while at a two carrier state 404, the mobile device can transition to a 1 carrier state by dropping a carrier 416 or the access point deallocating a carrier via transition 422. In addition, while at 2 carrier state 414, the mobile device can move to the one carrier state 416 by dropping a carrier via transition 424. States 414 and 416 can indicate where the mobile device has explicitly indicated that it cannot handle the maximum number of carriers, for example due to PA headroom limitations as described. Once PA headroom increase to a level allowing allocation of the maximum number of carriers, the mobile device can notify the access point accordingly.

From 2 carrier state 414, the mobile device can transmit a carrier request message to the access point, which can indicate that the mobile device can receive the maximum number of carriers. Thus, the mobile device can change to the 2 carrier state 404 via transition 426. From there, the mobile device can move between states 402, 404, and 406 based on access point considerations and actions as described. In addition, from the 2 carrier state 414, the mobile device can receive a TCA without solicitation, as described, allocating an additional carrier. This can cause the mobile device to move to the 3 carrier state 402 via transition 428. From 1 carrier state 416, the mobile device can request an additional carrier resulting in staying at the same state 416 via transition 430. However, if the access point allocates the additional carrier, whether based on a request or unsolicited TCA, the mobile device can move to the 2 carrier state 414 via transition 432. If from state 416, however, the mobile device acquires enough PA headroom to handle the maximum number of carriers (e.g. 3), it can transmit a carrier request message to the access point requesting the maximum moving to the 1 carrier state 406 via transition 434, where the access point has control over the number of allocated carriers, as described. Similarly, if from state 416 the access point allocates the maximum number of carriers to the mobile device by unsolicited TCA, it can move to the 3 carrier state 402 via transition 436.

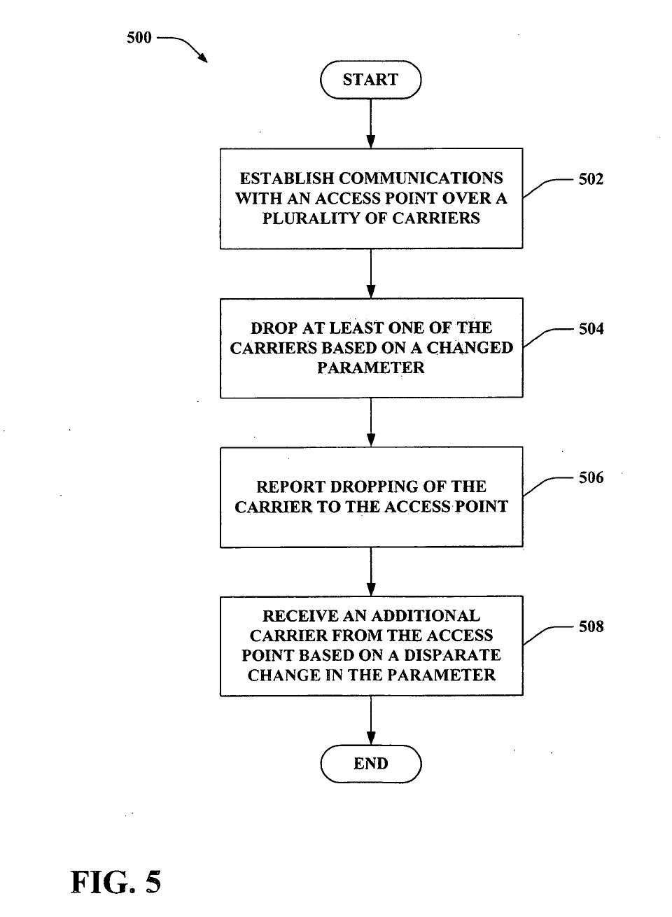

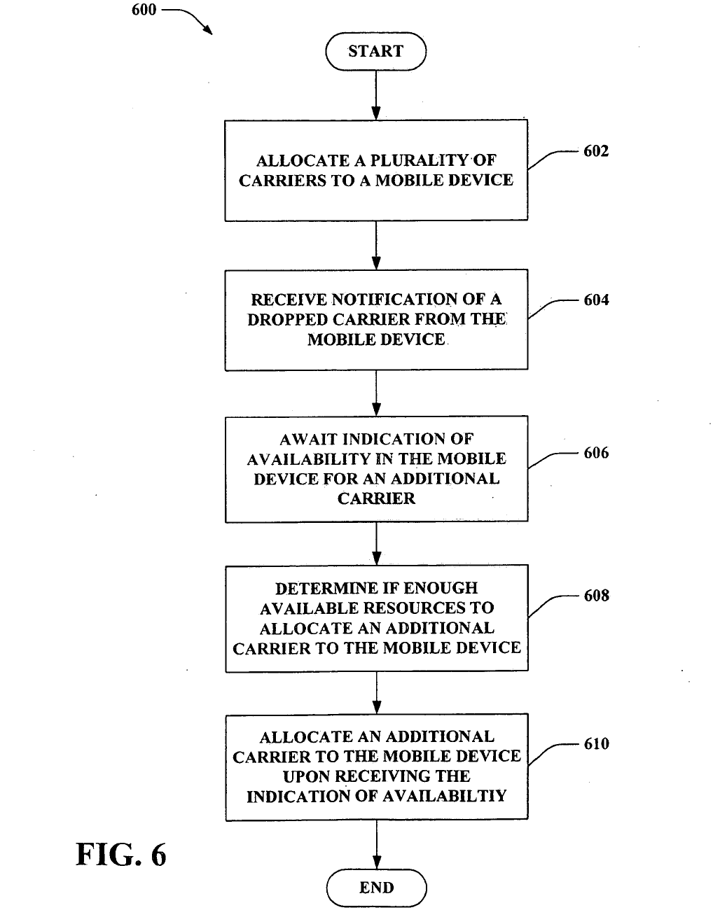

Referring to FIGS. 5-6, methodologies relating to adjusting carrier allocation to a mobile device in wireless communication networks are illustrated. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more embodiments.

Turning to FIG. 5, a methodology 500 that facilitates indicating drop and requested allocation of carriers in wireless communications is displayed. At 502, communications can be established with an access point over a plurality of carriers. As described, this can be a maximum number of carriers and/or a maximum number can be specified in communication establishment. At 504, at least one of the carriers can be dropped based at least in part on a changed parameter. The changed parameter can relate to the communication; in one example, the parameter can be PA headroom. Where the PA headroom decreases, a carrier can be dropped to account for the decrease allowing more reliable communication over remaining carriers, for example. At 506, dropping of the carrier can be reported to the access point. As described, this can allow the access point to await request for additional carrier before allocating such. At 508, an additional carrier can be received from the access point based on a disparate change in the parameter. The disparate change in the parameter can relate to the same or different parameter. In the example above, the changed parameter can again be the PA headroom, though this time the change can be an increase in the PA headroom, which allows room for an additional carrier allocation. The additional carrier can be received based on request, unsolicited TCA, and/or the like as described.

Turning to FIG. 6, illustrated is a methodology 600 that facilitates allocating carriers to a mobile device in wireless communications. At 602, a plurality of carriers can be allocated to a mobile device. This can occur upon communication establishment, for example, and can be based at least in part on a maximum number of carriers specified. At 604, a notification of a dropped carrier can be received from the mobile device. For example, the mobile device can drop a carrier based on its inability to effectively communicate over the carrier. This can be due to the mobile device's own inability and/or one or more conditions of the carrier, such as high activity and/or loading conditions on the carrier. At 606, indication of availability in the mobile device for an additional carrier can be awaited; this can include for example an increase in PA headroom such that the mobile device can effectively utilize the carrier. The indication can be based on a request for an additional carrier and/or determined, for example based on loading conditions of the dropped carrier and an additional carrier as described previously. At 608, it is determined whether there are enough available resources to allocate an additional carrier to the mobile device. At 610, an additional carrier can be allocated to the mobile device upon receiving the indication of availability. The allocation is further based on having enough resources. In one example, the additional carrier can be utilized by the mobile device in subsequent communication.

It will be appreciated that, in accordance with one or more aspects described herein, inferences can be made regarding determining when carriers should be dropped and/or requested as described. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

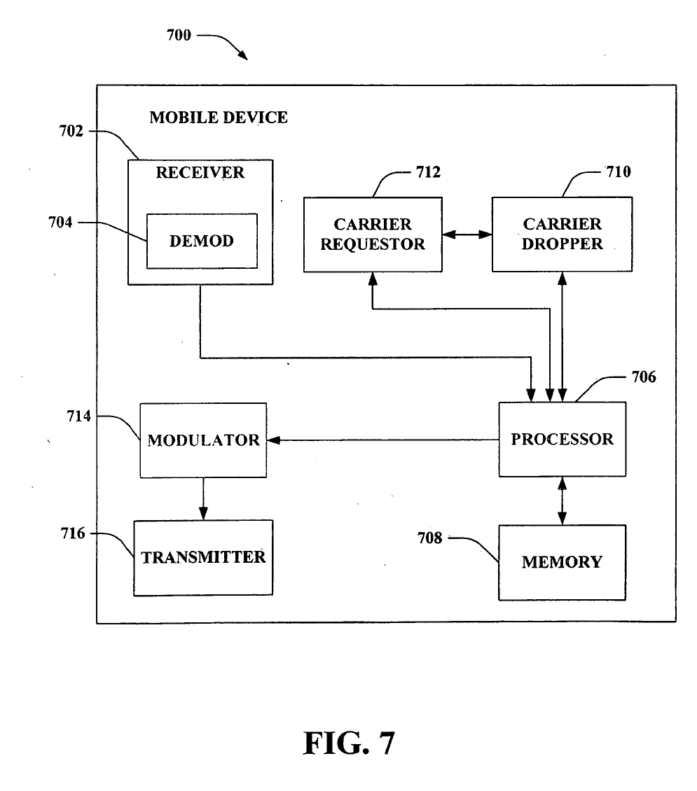

FIG. 7 is an illustration of a mobile device 700 that facilitates adjusting carrier allocation in wireless communication networks. Mobile device 700 comprises a receiver 702 that receives one or more signals over one or more carriers from, for instance, a receive antenna (not shown), performs typical actions on (e.g., filters, amplifies, downconverts, etc.) the received signals, and digitizes the conditioned signals to obtain samples. Receiver 702 can comprise a demodulator 704 that can demodulate received symbols and provide them to a processor 706 for channel estimation. Processor 706 can be a processor dedicated to analyzing information received by receiver 702 and/or generating information for transmission by a transmitter 716, a processor that controls one or more components of mobile device 700, and/or a processor that both analyzes information received by receiver 702, generates information for transmission by transmitter 716, and controls one or more components of mobile device 700.

Mobile device 700 can additionally comprise memory 708 that is operatively coupled to processor 706 and that can store data to be transmitted, received data, information related to available channels, data associated with analyzed signal and/or interference strength, information related to an assigned channel, power, rate, or the like, and any other suitable information for estimating a channel and communicating via the channel. Memory 708 can additionally store protocols and/or algorithms associated with estimating and/or utilizing a channel (e.g., performance based, capacity based, etc.).

It will be appreciated that the data store (e.g., memory 708) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 708 of the subject systems and methods is intended to comprise, without being limited to, these and any other suitable types of memory.

In an example, as described, the mobile device 700 can be initially allocated a maximum number of carriers in communicating with a base station or other wireless service access device. Processor 706 can further be operatively coupled to a carrier dropper 710 that can drop one or more of the allocated carriers when the mobile device 700 can no longer handle the carrier effectively. This can be caused, as described, by decrease in available PA headroom. Thus, upon detection of such a decrease by the carrier dropper 710, it can drop one or more carriers and provide notification of the drop to a wireless service access device, such as a base station. Upon increase of PA headroom beyond a threshold for handling one or more additional carriers, a carrier requestor 712, coupled to the processor 706, can be utilized to request an additional carrier from the wireless service access device, for example. Mobile device 700 still further comprises a modulator 714 and transmitter 716 that respectively modulate and transmit signals to, for instance, a base station, another mobile device, etc. Although depicted as being separate from the processor 706, it is to be appreciated that the carrier dropper 710, carrier requester 712, demodulator 704, and/or modulator 714 can be part of the processor 706 or multiple processors (not shown).

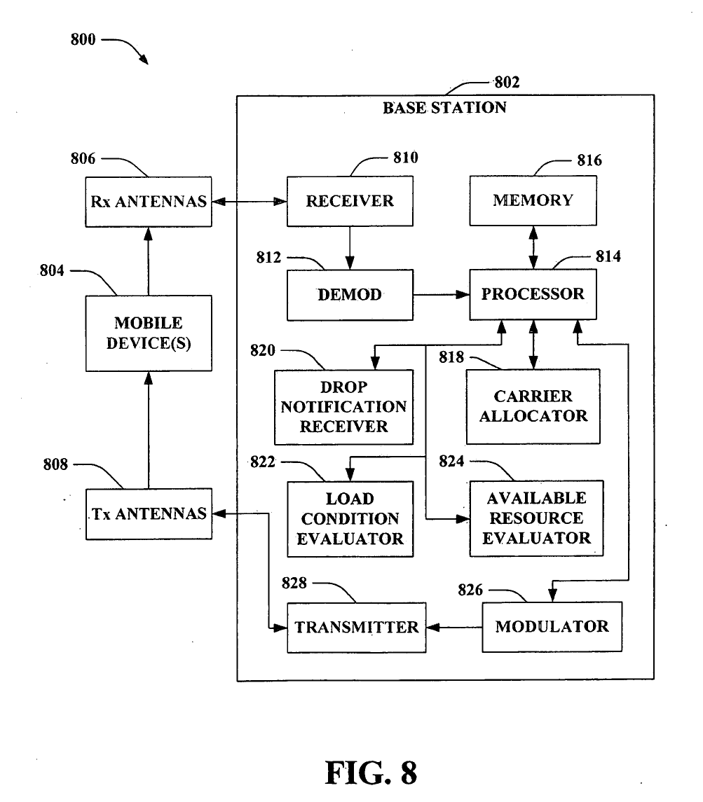

FIG. 8 is an illustration of a system 800 that facilitates allocating carriers to mobile devices in wireless communication networks. The system 800 comprises a base station 802 (e.g., access point, . . . ) with a receiver 810 that receives signal(s) from one or more mobile devices 804 through a plurality of receive antennas 806, and a transmitter 828 that transmits to the one or more mobile devices 804 through a transmit antenna 808. Receiver 810 can receive information from receive antennas 806 and is operatively associated with a demodulator 812 that demodulates received information. Demodulated symbols are analyzed by a processor 814 that can be similar to the processor described above with regard to FIG. 7, and which is coupled to a memory 816 that stores information related to estimating a signal (e.g., pilot) strength and/or interference strength, data to be transmitted to or received from mobile device(s) 804 (or a disparate base station (not shown)), and/or any other suitable information related to performing the various actions and functions set forth herein. Processor 814 is further coupled to a carrier allocator 818 that can allocate additional carriers to mobile device(s) 804 when needed as well as a drop notification receiver 820, load condition evaluator 822, and an available resources evaluator 824, that can be utilized to determine whether to allocate additional carriers to the mobile device(s) 804.

According to an example, drop notification receiver 820 can receive an indication from the mobile device(s) 804 of one or more dropped carriers. This can indicate, as described, that the mobile device(s) 804 could not handle the assigned carrier. In one example, this can be due to loading conditions on the dropped carrier. In this example, the load condition evaluator 822 can analyze the loading conditions on the dropped carrier and can locate an available carrier with improved loading conditions. If the available resource evaluator 824 indicates that there are enough resources available to allocate the available carrier, the carrier allocator 818 can do so and transmit carrier allocation information to the mobile device(s) 804, for example. In addition, the base station 802 can receive a carrier request message from the mobile device(s) 804 after dropping a carrier. The carrier allocator 818 can allocate additional carriers to the mobile device(s) 804 based on this request and/or on available resources according to available resource evaluator 824. Furthermore, although depicted as being separate from the processor 814, it is to be appreciated that the carrier allocator 818, drop notification receiver 820, load condition evaluator 822, available resource evaluator 824, demodulator 812, and/or modulator 826 can be part of the processor 814 or multiple processors (not shown).

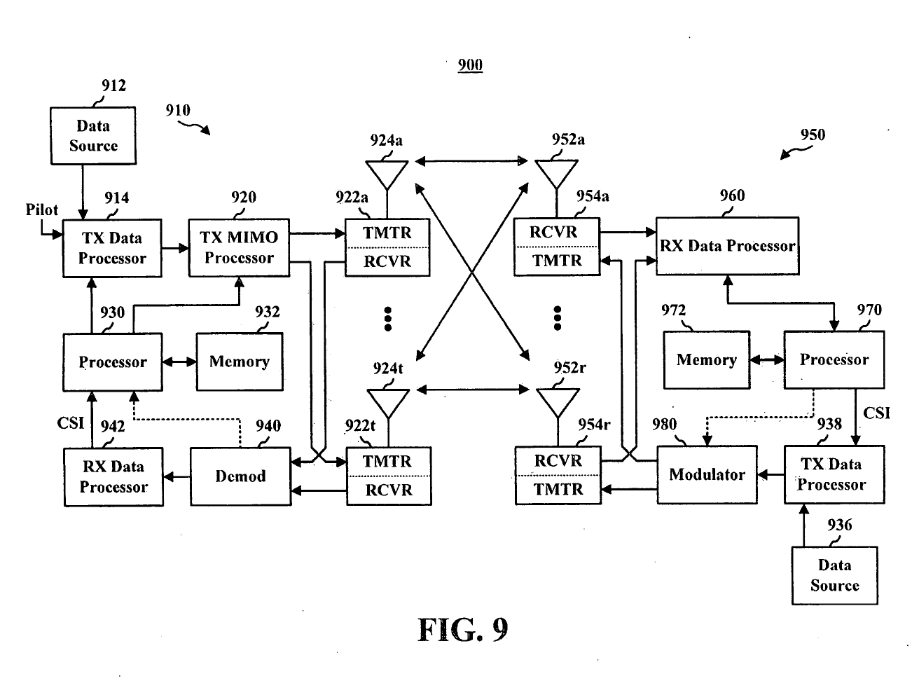

FIG. 9 shows an example wireless communication system 900. The wireless communication system 900 depicts one base station 910 and one mobile device 950 for sake of brevity. However, it is to be appreciated that system 900 can include more than one base station and/or more than one mobile device, wherein additional base stations and/or mobile devices can be substantially similar or different from example base station 910 and mobile device 950 described below. In addition, it is to be appreciated that base station 910 and/or mobile device 950 can employ the systems (FIGS. 1-4 and 7-8) and/or methods (FIGS. 5-6) described herein to facilitate wireless communication there between.

At base station 910, traffic data for a number of data streams is provided from a data source 912 to a transmit (TX) data processor 914. According to an example, each data stream can be transmitted over a respective antenna. TX data processor 914 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 950 to estimate channel response. The multiplexed pilot and coded data for each data stream can be modulated (e.g. symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 930.

The modulation symbols for the data streams can be provided to a TX MIMO processor 920, which can further process the modulation symbols (e.g., for OFDM). TX MIMO processor 920 then provides NT modulation symbol streams to NT transmitters (TMTR) 922a through 922t. In various embodiments, TX MIMO processor 920 applies beamforming weights to the symbols of the data streams and to the antenna from which the symbol is being transmitted.

Each transmitter 922 receives and processes a respective symbol stream to provide one or more analog signals, and further conditions (e.g. amplifies, filters, and upconverts) the analog signals to provide a modulated signal suitable for transmission over the MIMO channel. Further, N_{T} modulated signals from transmitters 922a through 922t are transmitted from N_{T} antennas 924a through 924t, respectively.

At mobile device 950, the transmitted modulated signals are received by N_{R} antennas 952a through 952r and the received signal from each antenna 952 is provided to a respective receiver (RCVR) 954a through 954r. Each receiver 954 conditions (e.g., filters, amplifies, and downconverts) a respective signal, digitizes the conditioned signal to provide samples, and further processes the samples to provide a corresponding “received” symbol stream.

An RX data processor 960 can receive and process the N_{R} received symbol streams from N_{R} receivers 954 based on a particular receiver processing technique to provide N_{T} “detected” symbol streams. RX data processor 960 can demodulate, deinterleave, and decode each detected symbol stream to recover the traffic data for the data stream. The processing by RX data processor 960 is complementary to that performed by TX MIMO processor 920 and TX data processor 914 at base station 910.

A processor 970 can periodically determine which preceding matrix to utilize as discussed above. Further, processor 970 can formulate a reverse link message comprising a matrix index portion and a rank value portion.

The reverse link message can comprise various types of information regarding the communication link and/or the received data stream. The reverse link message can be processed by a TX data processor 938, which also receives traffic data for a number of data streams from a data source 936, modulated by a modulator 980, conditioned by transmitters 954a through 954r, and transmitted back to base station 910.

At base station 910, the modulated signals from mobile device 950 are received by antennas 924, conditioned by receivers 922, demodulated by a demodulator 940, and processed by a RX data processor 942 to extract the reverse link message transmitted by mobile device 950. Further, processor 930 can process the extracted message to determine which precoding matrix to use for determining the beamforming weights.

Processors 930 and 970 can direct (e.g. control, coordinate, manage, etc.) operation at base station 910 and mobile device 950, respectively. Respective processors 930 and 970 can be associated with memory 932 and 972 that store program codes and data. Processors 930 and 970 can also perform computations to derive frequency and impulse response estimates for the uplink and downlink, respectively.

It is to be understood that the embodiments described herein can be implemented in hardware, software, firmware, middleware, microcode, or any combination thereof For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

When the embodiments are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

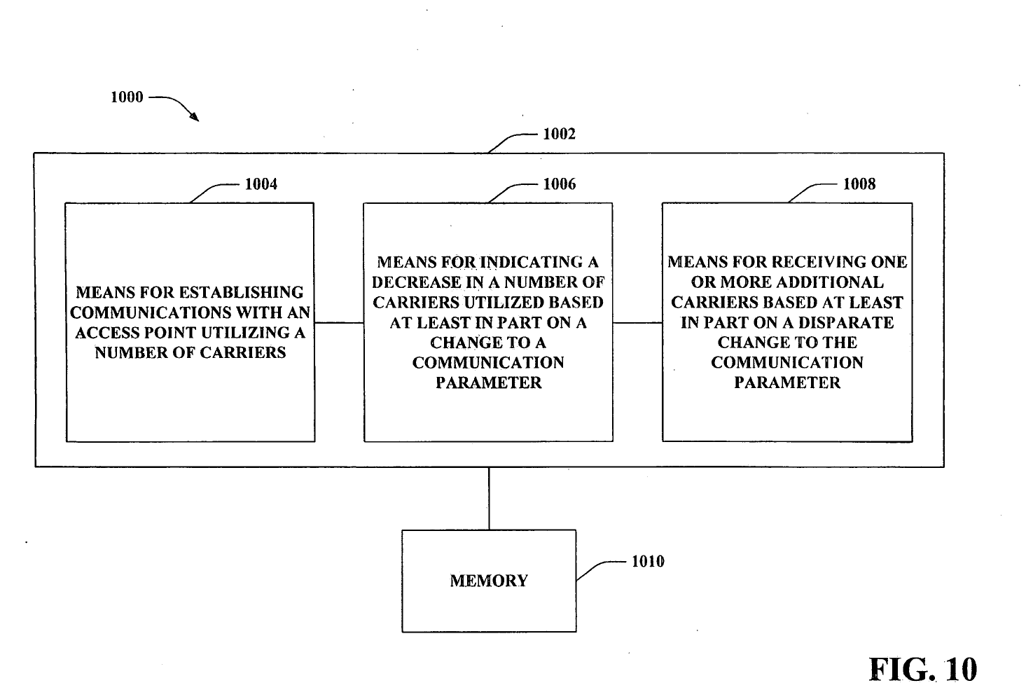

With reference to FIG. 10, illustrated is a system 1000 that drops and requests additional carriers for communication in a wireless network. For example, system 1000 can reside at least partially within a base station, mobile device, etc. It is to be appreciated that system 1000 is represented as including functional blocks, which can be functional blocks that represent functions implemented by a processor, software, or combination thereof (e.g., firmware). System 1000 includes a logical grouping 1002 of electrical components that can act in conjunction. For instance, logical grouping 1002 can include means for establishing communications with an access point utilizing a number of carriers 1004. For example, the system 1000 can receive wireless service from the access point over the assigned carriers. Further, logical grouping 1002 can comprise means for indicating a decrease in a number of carriers utilized based at least in part on a change to a communication parameter 1006. In one example, as described, the carrier can be dropped based on a decrease in PA headroom. Thus, the drop can be indicated to avoid allocation of one or more additional carriers due to the PA headroom decrease (e.g., since a new carrier could likely not be handled at least if it has similar loading conditions to the dropped carrier, as described). Furthermore, logical grouping 1002 can include means for receiving one or more additional carriers based at least in part on a disparate change to the communication parameter 1008. For example, a request for the additional parameter can be transmitted based on the disparate change, and the received carrier can be in response to the request, as described. Additionally, system 1000 can include a memory 1010 that retains instructions for executing functions associated with electrical components 1004, 1006, and 1008. While shown as being external to memory 1010, it is to be understood that one or more of electrical components 1004, 1006, and 1008 can exist within memory 1010.

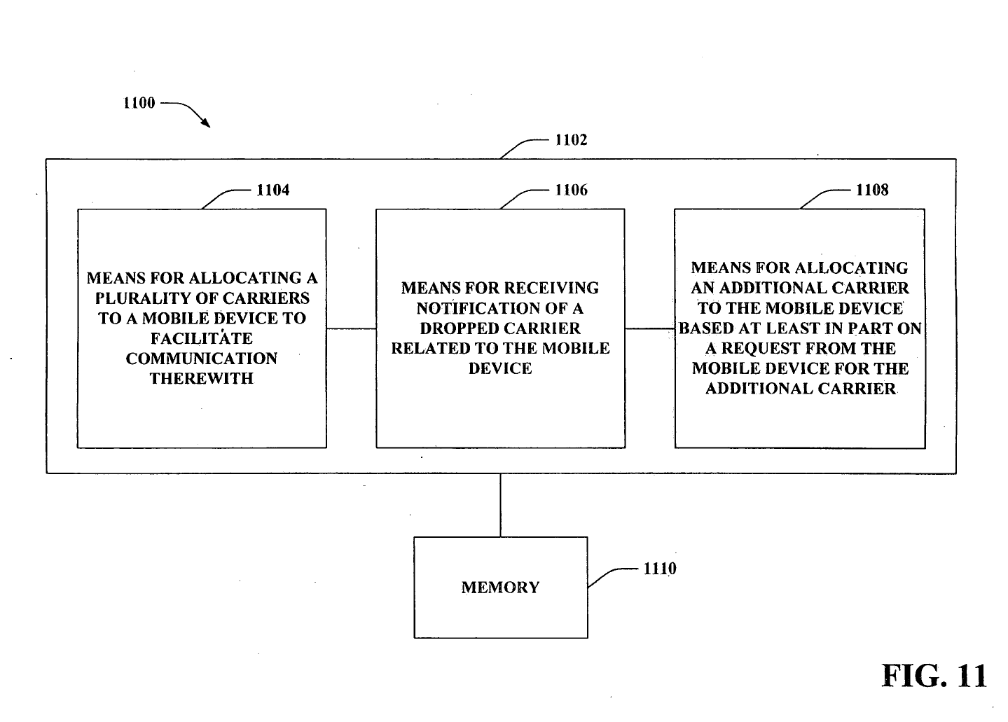

Turning to FIG. 11, illustrated is a system 1100 that receives notification of carrier drop and accordingly adjusts carrier allocation. System 1100 can reside within a base station, mobile device, etc., for instance. As depicted, system 1100 includes functional blocks that can represent functions implemented by a processor, software, or combination thereof (e.g. firmware). System 1100 includes a logical grouping 1102 of electrical components that facilitate adjusting carrier allocation. Logical grouping 1102 can include means for allocating a plurality of carriers to a mobile device to facilitate communication therewith 1104. As described, the allocated carriers can be a maximum number for the mobile device to facilitate increased throughput. Moreover, logical grouping 1102 can include means for receiving notification of a dropped carrier related to the mobile device 1106. The mobile device can drop the carrier for a variety of reasons, including decreased PA headroom or other reasons that prevent the mobile device from properly handling the carrier. Furthermore, logical grouping 1102 can also include means for allocating an additional carrier to the mobile device based at least in part on a request from the mobile device for the additional carrier 1108. In this regard, for example, if the PA headroom for the mobile device increases, it can request an additional carrier to maximize throughput, for example. Additionally, system 1100 can include a memory 1110 that retains instructions for executing functions associated with electrical components 1104, 1106, and 1108. While shown as being external to memory 1110, it is to be understood that electrical components 1104, 1106, and 1108 can exist within memory 1110.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

What is claimed is:

1. A method for modifying a number of carriers utilized in a wireless communication network, comprising:
establishing communications with an access point utilizing a plurality of carriers;
reporting dropping of one or more of the carriers as a result of a change in one or more communication parameters to the access point; and
receiving one or more additional carriers from the access point following a disparate change in the one or more communication parameters.

2. The method of claim 1, further comprising requesting the one or more additional carriers based at least in part on the disparate change.

3. The method of claim 2, further comprising setting a carrier request bar timer for prohibiting request of additional carriers based at least in part on detecting continuous requests for additional carriers and subsequent dropping of the requested carriers.

4. The method of claim 3, requesting the one or more carriers is further based at least in part on determining expiration of the carrier request bar timer.

5. The method of claim 2, requesting the one or more carriers is further based at least in part on performance over current carriers.

6. The method of claim 1, the one or more additional carriers received in an unsolicited traffic channel assignment from the access point.

7. The method of claim 1, further comprising receiving one or more disparate additional carriers from the access point following dropping the one or more additional carriers.

8. The method of claim 1, the one or more communication parameters includes a power amplifier (PA) headroom, the change is a decrease in the PA headroom, and the disparate change is an increase in the PA headroom.

9. The method of claim 1, the communications initialized over an evolution data optimized (EV-DO) network.

10. A wireless communications apparatus, comprising:
at least one processor configured to:
establish communications with an access point over a number of carriers assigned by the access point;
drop one or more of the carriers as a result of a change in one or more communications parameters; and
request one or more additional carriers based at least in part on a disparate change to the one or more communications parameters; and
a memory coupled to the at least one processor.

11. A wireless communications apparatus that facilitates adjusting a number of carriers utilized in wireless communications, comprising:
means for establishing communications with an access point utilizing a number of carriers;
means for indicating a decrease in a number of carriers utilized based at least in part on a change to a communication parameter; and
means for receiving one or more additional carriers based at least in part on a disparate change to the communication parameter.

12. A computer program product, comprising:
a computer-readable medium comprising:
code for causing at least one computer to establish communications with an access point utilizing a plurality of carriers;
code for causing the at least one computer to report dropping of one or more of the carriers as a result of a change in one or more communication parameters to the access point; and
code for causing the at least one computer to receive one or more additional carriers from the access point following a disparate change in the one or more communication parameters.

13. An apparatus, comprising:
a transceiver that facilitates establishing communications with an access point over a plurality of assigned carriers;
a carrier dropper that transmits an indication of one or more dropped carriers to the access point based at least in part on a change of a communications parameter; and
a carrier receiver that receives one or more additional carriers from the access point based at least in part on a disparate change to the communications parameter.

14. The apparatus of claim 13, further comprising a carrier requestor that requests the one or more additional carriers based at least in part on the disparate change.

15. The apparatus of claim 14, the carrier requestor determines an aggressive drop state based at least in part on repeated requests for additional carriers and subsequent dropping of the requested carriers.

16. The apparatus of claim 15, the carrier requestor further requests the one or more carriers based at least in part on the aggressive drop state.

17. The apparatus of claim 14, the carrier requestor further requests the one or more carriers based at least in part on performance over current carriers.

18. The apparatus of claim 13, the carrier receiver receives the one or more additional carriers in an unsolicited traffic channel assignment from the access point.

19. The apparatus of claim 13, the carrier receiver obtains one or more disparate additional carriers from the access point following dropping the one or more additional carriers.

20. The apparatus of claim 13, the one or more communication parameters includes a power amplifier (PA) headroom, the change is a decrease in the PA headroom, and the disparate change is an increase in the PA headroom.

21. A method that facilitates allocating carriers in wireless communication networks, comprising:
allocating a plurality of carriers to a mobile device according to a maximum number of allocable carriers associated with the mobile device;
receiving an indication of dropping one or more of the allocated carriers from the mobile device; and
allocating an additional carrier to the mobile device based at least in part on determining an availability in the mobile device for the additional carrier.

22. The method of claim 21, determining the availability is based at least in part on evaluating activity of a reverse link channel of the one or more allocated carriers.

23. The method of claim 21, determining the availability is based at least in part on receiving a request from the mobile device for the additional carrier.

24. The method of claim 21, allocating the additional carrier is further based at least in part on determining loading conditions for the additional carrier.

25. The method of claim 24, allocating the additional carrier is further based at least in part on comparing the loading conditions for the additional carrier to loading conditions for the allocated carrier for which the indication of dropping is received.

26. The method of claim 21, allocating the additional carrier is further based on determining drop characteristics of the mobile device related to previously requested additional carriers.

27. The method of claim 21, the plurality of carriers are allocated to the mobile device in an evolution data optimized (EV-DO) network.

28. A wireless communications apparatus, comprising:
at least one processor configured to:
allocate a plurality of carriers to a mobile device to facilitate communication therewith;
receive a notification of a drop in at least one of the carriers by the mobile device; and
allocate an additional carrier to the mobile device based at least in part on a subsequently received request for the additional carrier; and
a memory coupled to the at least one processor.

29. A wireless communications apparatus for adjusting carrier allocation of one or more mobile devices, comprising:
means for allocating a plurality of carriers to a mobile device to facilitate communication therewith;
means for receiving notification of a dropped carrier related to the mobile device; and
means for allocating an additional carrier to the mobile device based at least in part on a request from the mobile device for the additional carrier.

30. A computer program product, comprising:
a computer-readable medium comprising:
code for causing at least one computer to allocate a plurality of carriers to a mobile device according to a maximum number of allocable carriers associated with the mobile device;
code for causing the at least one computer to receive an indication of dropping one or more of the allocated carriers from the mobile device; and
code for causing the at least one computer to allocate an additional carrier to the mobile device based at least in part on determining an availability in the mobile device for the additional carrier.

31. An apparatus, comprising:
a transceiver that communicates with one or more mobile devices over a plurality of allocated carriers;
a drop carrier notification receiver that receivers an indication that the mobile device has dropped one or more of the allocated carriers; and
a carrier allocator that allocates an additional carrier to the mobile device based at least in part on determining availability in the mobile device for the additional carrier.

32. The apparatus of claim 31, determining the availability is based at least in part on evaluating activity of a reverse link channel of the one or more allocated carriers.

33. The apparatus of claim 31, determining the availability is based at least in part on receiving a request from the mobile device for the additional carrier.

34. The apparatus of claim 31, the carrier allocator allocates the additional carrier further based at least in part on determining loading conditions for the additional carrier.

35. The apparatus of claim 34, the carrier allocator allocates the additional carrier further based at least in part on comparing the loading conditions for the additional carrier to loading conditions for the dropped allocated carrier.

36. The apparatus of claim 31, the carrier allocator allocates the additional carrier further based on determining drop characteristics of the mobile device related to previously requested additional carriers.
